(19) United States
(12) Patent Application Publication
(10) Pub. No.: US 2014/0349239 A1
(43) Pub. Date: Nov. 27, 2014

(54) METHOD FOR CHANGING HEAT TRANSFER BED DEPTH IN PACKED BED HEAT EXCHANGERS

(71) Applicant: FLSmidth A/S, Valby (DK)

(72) Inventors: Gene Basara, II, Bethlehem, PA (US); Charles Euston, Bethlehem, PA (US)

(21) Appl. No.: 14/366,847

(22) PCT Filed: Dec. 27, 2012
(86) PCT No.: PCT/US2012/071810

§ 371 Date: Jun. 19, 2014

Related U.S. Application Data
(60) Provisional application No. 61/581,285, filed on Dec. 29, 2011.

(51) Int. Cl. F27B 15/00; C04B 2/12

(52) U.S. Cl. CPC F27B 15/006; C04B 2/12
USPC 432/100

(57) ABSTRACT

A limestone preheater which segregates material according to particle size and further provides for material bed depth adjustment, preferably during operation.

This application claims the benefit of U.S. Provisional Application No. 61/581,285, filed Dec. 29, 2011.

### BACKGROUND OF THE INVENTION

This invention relates to a method and apparatus for preheating particulate material and, more particularly, to an improved method and apparatus for more efficiently preheating particulate material.

Although the present invention is applicable generally to the preheating of particulate material, it is particularly applicable to the preheating and precalcining of limestone by flowing the limestone and the hot kiln gases from the calcining kiln in countercurrent heat exchange relationship to each other.

A prior art packed bed preheating and precalcining apparatus for particulate material such as lime is seem in FIG. 1. Such an apparatus comprises a containment vessel 10 having a floor 11 with a center section 12. A vertically oriented annular preheating section 13 having an upper and lower area circles the center section. The annular preheating section 13 has an outer wall 14, which typically also serves as the outer wall of the containment vessel, and an inner wall 15, said inner wall having a lower side 16 that is spaced above the floor to form an arch or bull nose. The center section of the floor opens into a material outlet 12a for discharging preheated particulate material out of the apparatus. There is a material inlet 17 toward the top of the annular preheating section for receiving particulate material from a feed bin 18 into the section, with the material falling downward toward floor 11. Preheating gas from rotary kiln 19 is directed into the annular preheating section as per arrows A in countercurrent flow to the material. A plurality of air outlets 20 discharge the gas from the annular preheating section after the gas has passed through the particulate material in the section and direct the gas into common gas exhaust 21. The preheating apparatus also comprises a ram plunger feeder 22 having a leading pusher face that comes into contact with the particulate material. The plunger feeder, which is located adjacent to or is in contact with the floor, is reciprocally and essentially radially and reciprocally movable from a first retracted position located closer to the outer wall of the annular preheating section to a second extended position located away from the outer wall and toward the material outlet of the chamber for contacting the particulate material and moving it under the arch and toward the material outlet. The preheater is typically cylindrical but can be rectangular, and the annular passageway may be subdivided into compartments or chimneys by one or more radially extending walls that extend from the outer wall to the inner wall.

Alternatively, the preheater may contain individual material cassettes in the manner taught in U.S. Pat. No. 6,926,522, which teaches that the particulate material is directed from the feed bin or bins into a plurality of essentially vertical cylindrical feed cassettes via intermediate feed ducts. Each feed cassette is completely segregated from its adjacent cassettes. The particulate material falls from each cassette into the annular flow passage section of the lower chamber. A plurality of ram plungers, the number of which corresponds to the number of cassettes, discharges particulate material that has fallen into the annular flow chamber from the overhanging cassettes into a material outlet located in the floor located at the center of the lower chamber.

It is known that in such packed bed heat exchangers used to preheat materials such as limestone the amount of heat exchange and pressure drop through the material bed is determined in part by the size graduation of the raw material, the temperature and quantity of the gas, and the bed depth. Packed bed heat exchangers typically cannot effectively adjust to different particle size graduations.

It is therefore an object of this invention to have a preheater that can adjust to different particle size graduations.

### SUMMARY OF THE INVENTION

The current invention provides for a limestone preheater which segregates material according to particle size and further provides for material bed depth adjustment, preferably during operation. Pursuant to the present invention, changes in particle size graduations (for example to allow for better quarry utilization) can easily be accommodated while maintaining optimal preheater performance.

### DESCRIPTION OF THE DRAWINGS

FIG. 1 is an elevational view of a prior art preheater.

FIG. 2 is an elevational sectional view of one cassette in a prior art preheater.

FIGS. 3-4 are elevational views of a preheater segment of the present invention, shown as if sliced in half vertically.

FIG. 5 is a side elevational view of a cassette in the preheater of the present invention.

FIG. 6 is a front elevational view of a cassette in the preheater of the present invention.

FIG. 7 is a side elevational view of a cassette in the preheater of the present invention showing material flow of the present invention.

### DETAILED DESCRIPTION OF THE INVENTION

It is known that resistance to airflow increases as particle size decreases. This can affect the preheating quality in material preheaters such as limestone preheaters. These preheaters typically will treat irregular size feeds which can lead to uneven preheating. It has been discovered that in order to achieve more uniform flow rates and improved preheating through piles of different size stone, it is necessary to first segregate the various sized stones into discreet areas of the preheater and then adjust the various bed heights of the differently vertically sized piles of stones to a point where there is more even air flow rates through the various stone piles, that is, where the sizes of the various piles of material have been adjusted so that pressure drop across a pile of fine materials is as close as possible to the pressure drop across a pile of coarse materials. Thus, by classifying the stone entering a preheating chamber and then carefully adjusting pile depth while keeping the flow rate of material into the preheater constant, a more even flow through the material can be realized.

The present invention raises and lowers the material pile depth within a preheater by extending or retracting a material feed pipe within the preheating chamber.

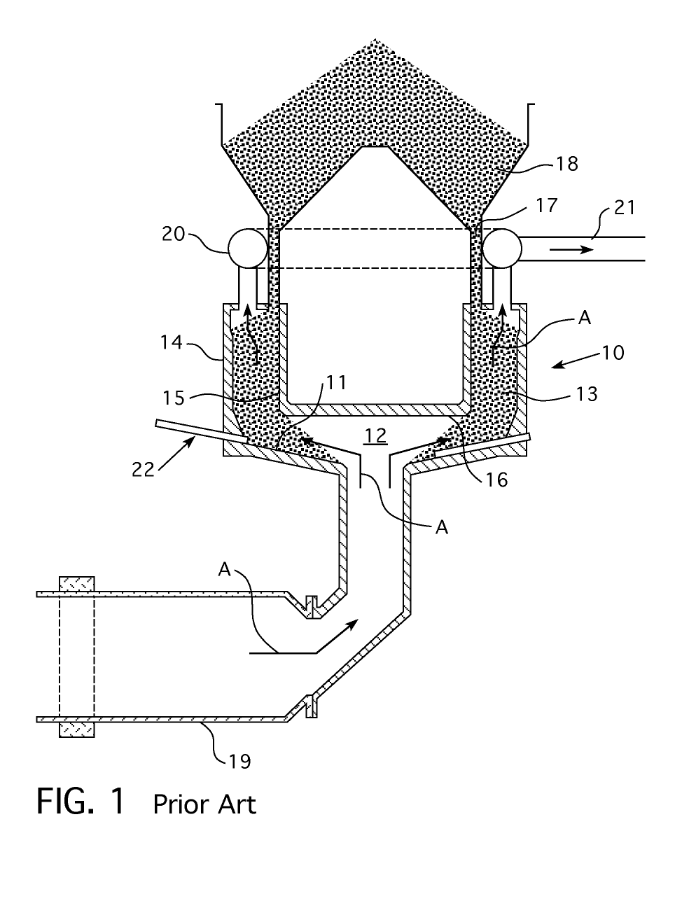

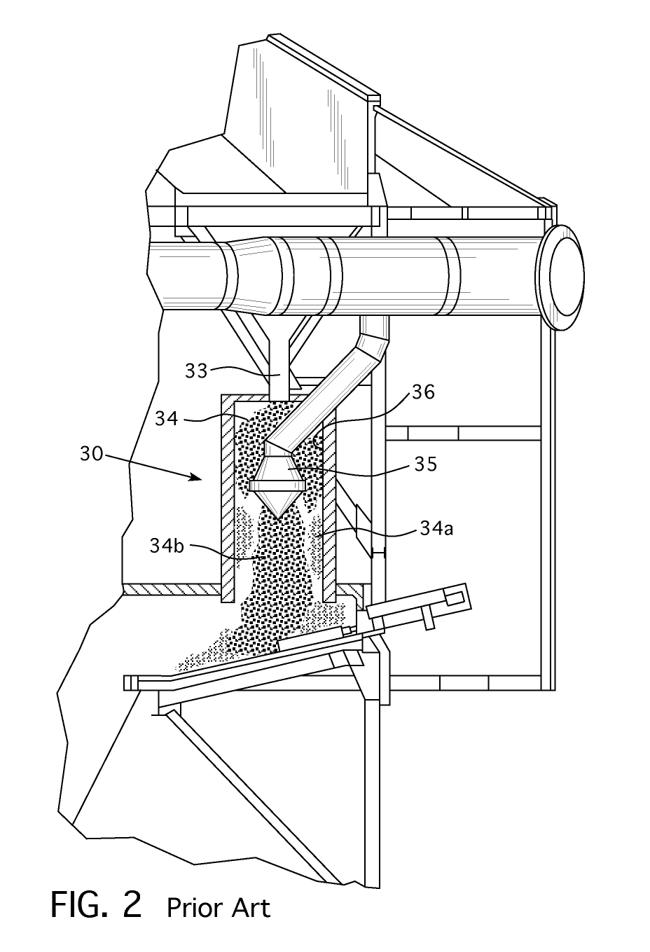

FIG. 2 illustrates an individual cassette 30 of a preheater as taught in U.S. Pat. No. 6,926,522. Material feed 34 enters cassette essentially vertically by gravity from a feed inlet pipe 33, preferably through a location essentially in the center of upper face 32 of cassette 30. In the depicted embodiment, air intake 35 is positioned in the interior of cassette 30 directly below feed pipe 33 so that a substantial amount of feed 34 entering cassette 30 from feed inlet pipe 33 will fall on the top of air intake 35. Coarser material 34b will roll around and down the side of air take off 35 and from there travel down through the center of feed cassette 30. Fine material 34a will tend to migrate toward the inside wall 36 of cassette 30. This design contributes to a natural segregation of fine material 34a from coarse material 34b. This segregation of coarse and fine materials promotes better gas distribution over the full cross-section of the cassette than is provided for in the preheater as depicted in FIG. 1.

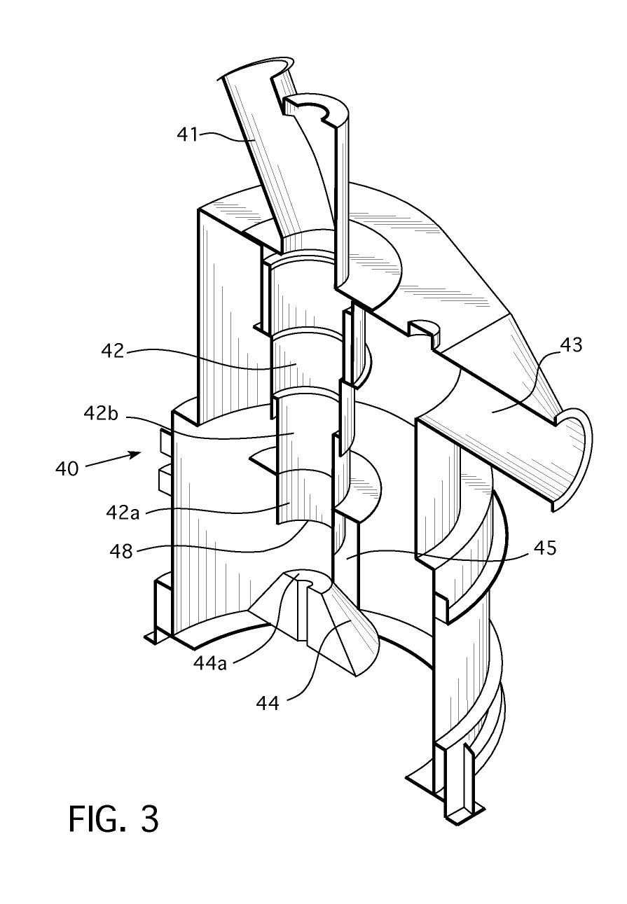

FIG. 3 illustrates one embodiment of a preheater according to the present invention, in which the interior of cassette 40 is depicted. Such a cassette is utilized in a preheater that generally has a plurality (typically eight or more) of identical cassettes. Material to be preheated enters the cassette through material inlet passage 41 and is directed into tubular, vertically oriented feed pipe 42 through feed pipe entry point 42y. Feed pipe 42 extends vertically downward into the preheating area. Preheating air exits through conduit 43 located in the upper area of the cassette. Material travels down feed pipe 42 and upon exiting the feed pipe impacts with classifier 44, which is located underneath the feed pipe material exit and which in the depicted embodiment is attached to bottommost section 42a of feed pipe 42 by bracket 45.

Classifier 44 as depicted is in the shape of a truncated cone, with its smaller parallel base being 44a located closer to the end 48 (material exit point) of feed pipe 42 and the larger parallel base being located closer to the floor of the preheater. Classifier 44 can have other shapes that suitable for particle size classifier by impact, such as a truncated square pyramid, a truncated pyramid or a semi-circular or arc shape. Feed pipe 42 and therefore classifier 44 are located approximately on the vertical centerline of the cassette 40.

The finer the material impacting with the classifier 40, the further the material will migrate from the center of the cassette, with the finest material being scattered toward the outer perimeter of the cassette. Therefore, in the roughly circular material pile that builds up from the preheater floor directly underneath cassette 40, the finest material will build up on the outside of the pile and the coarsest material will make up the center-most portion of the pile.

It is a feature of the present invention that it provides for a means of raising and lowering the material pile that builds up from the floor of the preheater by raising and lowering the feed pipe, which in the depicted embodiment is comprised of a plurality of interfitting and telescoping sections 42a, 42b and so forth. Therefore feed pipe 42 can be extended vertically downward into the interior of the cassette 40 or it can be shortened considerably by having the sections retract into themselves. When the feed pipe is at its most retracted position the bed depth of the material pile in the preheater area located under a specific feed pipe (whether it be in a cassette, chimney or an open annular preheating area) will be at its highest and when the feed pipe is at its most extended position the bed depth of the material pile will be at its lowest.

Depending upon the specific composition of the feed (which can vary because of a number of factors, including the quarry location) a practitioner of the invention can optimize the preheating capabilities of the preheater. If a particular practitioner has more fines, relatively speaking, in the feed the preheater efficiency can be optimized by lowering the feed pipe in the preheating chamber and thereby lowering the bed height.

The fewer fines in the feed the preheater efficiency can be optimized by raising the feed pipe in the preheating chamber and thereby increasing the bed height. Furthermore, there can be different feed size mixtures in different areas of the feed bin and thus one feed inlet can receive feeds having different size characteristics than another feed inlet in the same preheater. Therefore it may be advantageous to separately adjust the bed depth under each feed pipe in a preheater.

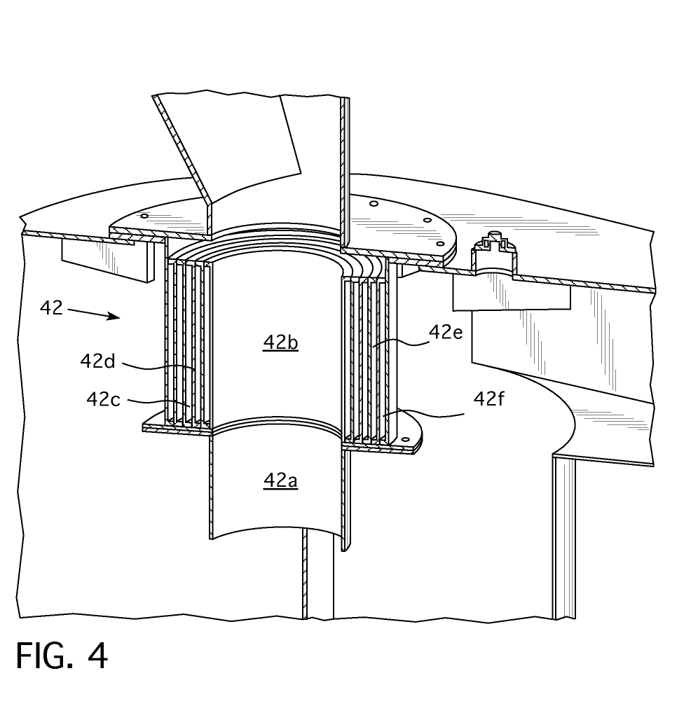

FIG. 4 illustrates the feed pipe 42 in which all but section 42a have been retracted. It this embodiment the feed pipe has six sections 42a-f, although the number of pipe sections is not critical to the invention. Uppermost section 42f has the largest diameter and lowermost section 42a has the smallest diameter, and each section is capable of fitting inside the section immediately above it, i.e. section 42a can fit into section 42b, and sections 42a and 42b can fit inside section 42c, and so forth.

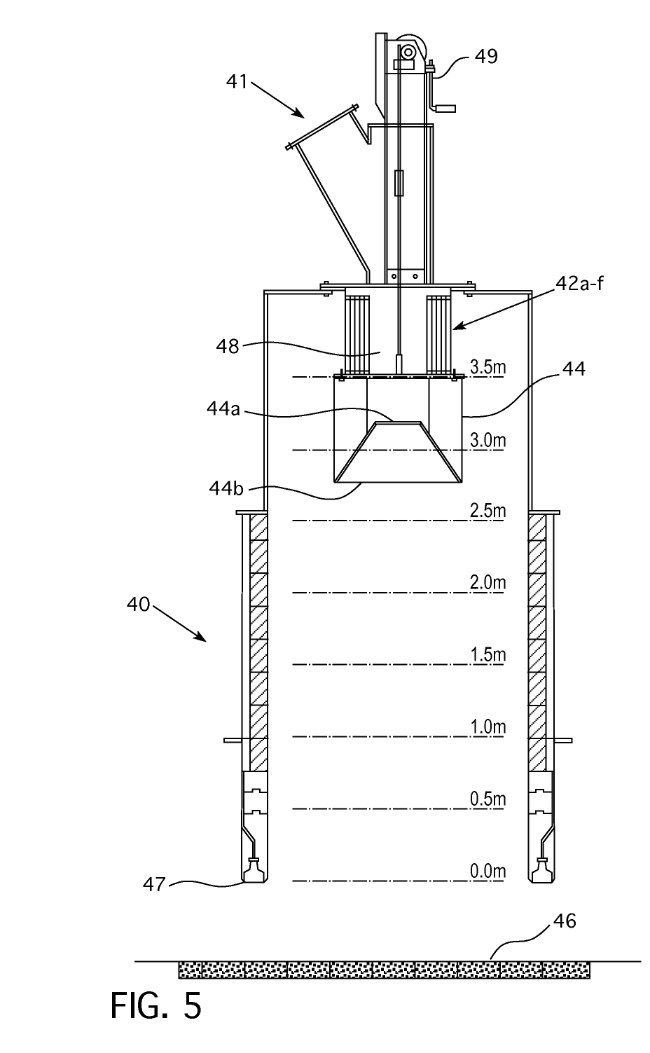

FIG. 5 illustrates a side elevation of a preheater section 40, in this example a cassette, and a preheater feed pipe 42 used in the present invention. The cassette is partially lined by refractory 50 to improve preheating. As depicted feed pipe sections 42a-f are shown in the most retracted position, and therefore classifier 44 is in the highest position relative to stone floor 46. The distances shown in the figure indicate the feed pipe's elevation above the bullnose 47. In the depicted position outlet 48 of the feed pipe is located approximately 3.5 meters above bullnose 47; the larger parallel base 44b of the classifier is positioned approximately 2.75 meters above bullnose 47; and the upper parallel base 44a of the classifier is located approximate 0.3 meters beneath the outlet 48 of the feed pipe. The bullnose is typically position from 1 to 2 meters above the preheater floor. These dimensions are exemplary only and can be varied by the practitioners depending on factors including the type of preheater utilized (e.g. cassette, chimney or open preheating area).

The feed pipe 42, and accordingly the material bed depth, can be raised or lowered while in operation through the use of hoist 49 which is located exterior to the cassette. It is understood that the distances depicted are exemplary only and can be varied by the practitioner, along with the method of raising and lowering the cassette, which can be done manually, electrically, automatically or semi-automatically. In addition, any method of determining the feed size being delivered to the preheater can be utilized in the present invention.

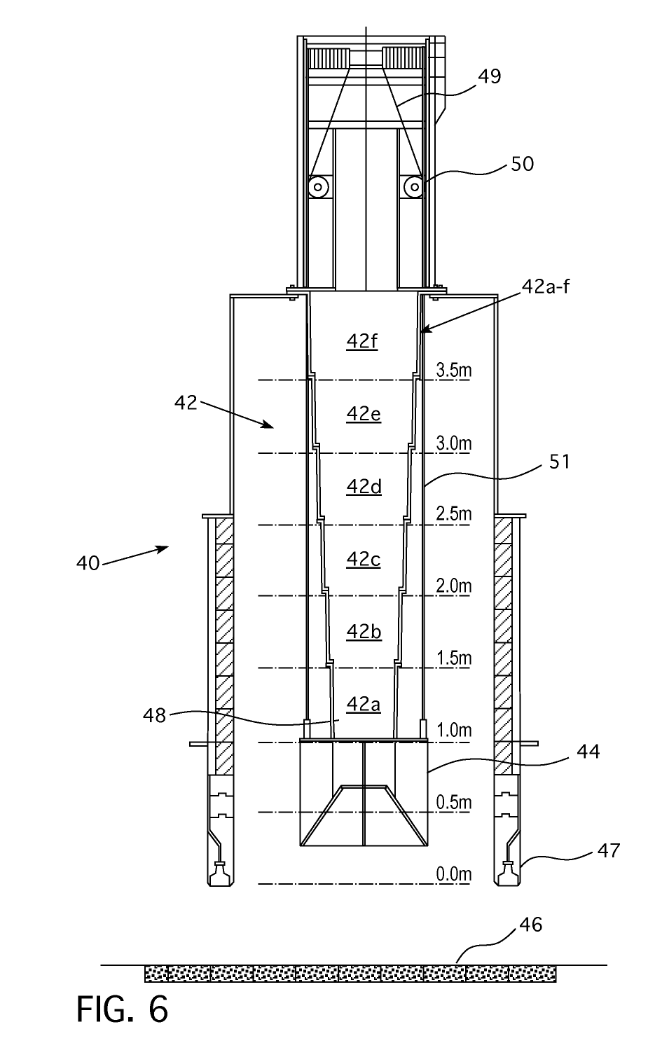

FIG. 6 illustrates a side elevation of a preheater section 40, in which adjustable telescoping feed pipe 42 is fully extended. As depicted, feed outlet 48 is located approximately one meter above the bullnose. Therefore, in the example set forth in the FIGS. 6 feed pipe 42 is extended 2.5 meters from the position depicted in FIG. 5. The depicted mechanism for raising and lowering feed pipe comprises hoist 49, pulley 50 and guide wire 51.

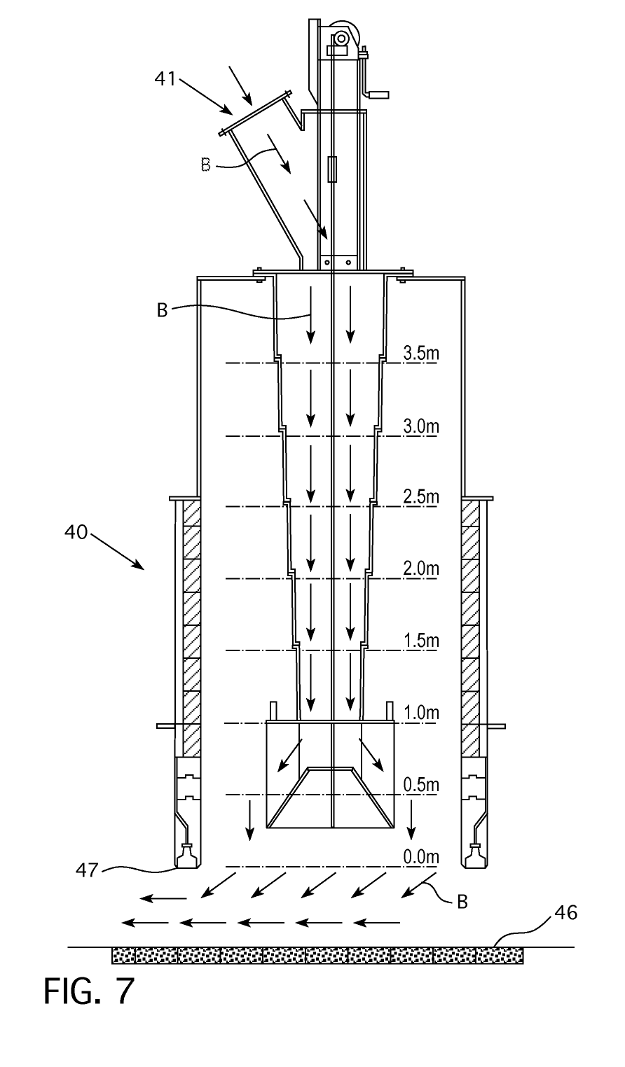

In FIG. 7 the flow of the material into, through and out of cassette 40 is detailed by arrows B. Stone feed enters through inlet 41 and flows down through feed pipe 42, impacts classifier 44 and falls toward floor 46. The feed is directed under bullnose 47 toward the center of floor 46 by the action of a reciprocating plunger feeder (not shown).

Although the present invention has been described with reference to preferred embodiments, workers skilled in the art will recognize that changes may be made in form and detail without departing from the spirit and scope of the invention.

What is claimed is:

1. A preheating apparatus for particulate material comprising:
a containment vessel;
a floor to said containment vessel having a material outlet for discharging preheated particulate material out of the apparatus;
a vertically oriented outer annular preheating section which circles the material outlet;
a feed pipe having a material entry and material exit, said feed pipe extending vertically downward into the preheating section to deliver particulate material into the annular preheating section to form a material pile in the preheating section extending above the floor, said feed pipe being adaptable to be extended or retracted within the preheating section to thereby lower or raise the material pile;
means to deliver hot gas into the annular preheating section; and
means to discharge said gas from the annular preheating section after the gas has passed through the particulate material in the section.

2. The preheating apparatus of claim 1 wherein the feed pipe is comprised of a plurality of interfitting pipe sections.

3. The preheating apparatus of claim 1 wherein the means to extend and retract the feed pipe can be operated while the preheater is in operation.

4. The preheating apparatus of claim 1 further comprising feed classifier means positioned underneath the feed pipe material exit adaptable to classify the material as said material exits the feed pipe.
